(19) United States
(12) Patent Application Publication
(10) Pub. No.: US 2026/0163176 A1
(43) Pub. Date: Jun. 11, 2026

(54) METHOD FOR MANUFACTURING SOLID ELECTROLYTE LAYER AND METHOD FOR MANUFACTURING SECONDARY BATTERY

(71) Applicant: TOYOTA JIDOSHA KABUSHIKI KAISHA, Toyata-shi (JP)

(72) Inventor: Manabu IMANO, Nagoya-shi (JP)

(73) Assignee: TOYOTA JIDOSHA KABUSHIKI KAISHA, Toyata-shi (JP)

(21) Appl. No.: 19/396,032

(22) Filed: Nov. 20, 2025

(30) Foreign Application Priority Data
Dec. 10, 2024 (JP) 2024-215189

(51) Int. Cl. H01M 50/403; H01M 50/449

(52) U.S. Cl. CPC H01M 50/403; H01M 50/449

(57) ABSTRACT

A method for manufacturing a solid electrolyte layer includes: a step of preparing a solid electrolyte slurry by mixing a solid electrolyte, a conductive additive, a binder, and a solvent; a step of obtaining a parameter of the solid electrolyte slurry using a dynamic viscoelasticity measuring device; a step of determining the quality of a coating film based on the parameter; and a step of applying the solid electrolyte slurry that has been determined to be acceptable in the step of determining the quality of the coating film.

### CROSS-REFERENCE TO RELATED APPLICATION

This application claims priority to Japanese Patent Application No. 2024-215189 filed on Dec. 10, 2024. The disclosure of the above-identified application, including the specification, drawings, and claims, is incorporated by reference herein in its entirety.

### BACKGROUND

### 1. Technical Field

The present disclosure relates to methods for manufacturing a solid electrolyte layer included in a secondary battery.

### 2. Description of Related Art

In the manufacture of electrodes for secondary batteries, an electrode mixture for forming an active material layer is prepared using an active material (solid powder), a binder (paste), and a solvent (liquid) as raw materials. Japanese Patent No. 7031259 (JP 7031259 B) discloses a manufacturing method in which electrode coating is performed while maintaining a constant thixotropy index value of a paste as measured with a viscometer.

### SUMMARY

However, the thixotropy index value measured with a viscometer alone is not sufficient to determine the quality of the coating film that will be formed. That is, it may not become apparent until after the coating film is actually formed that the film is unsatisfactory, which results in wasted coating work.

Accordingly, an object of the present disclosure is to provide a method for manufacturing a solid electrolyte layer that enables efficient formation of an appropriate coating film.

The present specification discloses a method for manufacturing a solid electrolyte layer. The method includes: a step of preparing a solid electrolyte slurry by mixing a solid electrolyte, a conductive additive, a binder, and a solvent; a step of obtaining a parameter of the solid electrolyte slurry using a dynamic viscoelasticity measuring device; a step of determining the quality of a coating film based on the parameter; and a step of applying the solid electrolyte slurry that has been determined to be acceptable in the step of determining the quality of the coating film.

The parameter may be obtained from stress-strain.

The stress-strain may be measured in a shear stress range of 0.01 Pa to 100 Pa.

The present application also discloses a method for manufacturing a secondary battery. The method includes the steps of the above method for manufacturing a solid electrolyte layer.

According to the present disclosure, while in the state of a solid electrolyte slurry, a physical property parameter is measured using a dynamic viscoelasticity measuring device. This allows the quality of a coating film that would be formed by applying the solid electrolyte slurry to be predicted and determined in advance. As a result, wasted coating work can be reduced, and an appropriate coating film can be efficiently obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates the layer structure of an all-solid-state battery 10.

### DETAILED DESCRIPTION OF EMBODIMENTS

### 1. Secondary Battery

Although an all-solid-state battery is herein described as one aspect of a secondary battery, the secondary battery is not limited to this as long as a solid electrolyte layer contains a solid electrolyte. The secondary battery may include an electrolyte solution.

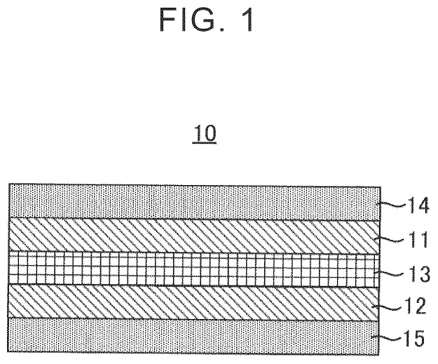

FIG. 1 is a schematic cross-sectional view showing an example of an all-solid-state battery. As shown in FIG. 1, the all-solid-state battery 10 includes a cathode active material layer 11 containing a cathode active material; an anode active material layer 12 containing an anode active material; a solid electrolyte layer 13 formed between the cathode active material layer 11 and the anode active material layer 12; a cathode current collector layer 14 that collects current from the cathode active material layer 11; and an anode current collector layer 15 that collects current from the anode active material layer 12. The cathode active material layer 11 and the cathode current collector layer 14 may collectively be referred to as cathode layer, and the anode active material layer 12 and the anode current collector layer 15 may collectively be referred to as anode layer.

Each component of the all-solid-state battery 10 will be described below.

### 1.1. Cathode Active Material Layer

The cathode active material layer 11 is a layer containing a cathode active material, and further contains a solid electrolyte, a conductive additive, and a binder. The cathode active material may be a known active material. Examples include cobalt-based materials (LiCoO₂ etc.), nickel-based materials (LiNiO₂ etc.), manganese-based materials (LiMn₂O₄, Li₂Mn₂O₃, etc.) iron phosphate-based materials (LiFePO₄, Li₂FeP₂O₇, etc.), NCA-based materials (compounds of nickel, cobalt, and aluminum), and NMC-based materials (compounds of nickel, manganese, and cobalt). More specific examples include LiNi_{1/3}Co_{1/3}Mn_{1/3}O₂. The surface of the cathode active material may be coated with an oxide layer such as a lithium niobate layer, a lithium titanate layer, or a lithium phosphate layer.

The solid electrolyte is preferably an inorganic solid electrolyte. This is because inorganic solid electrolytes exhibit higher ionic conductivity and superior heat resistance compared to organic polymer electrolytes. Examples of inorganic solid electrolytes include sulfide solid electrolytes and oxide solid electrolytes. Examples of sulfide solid electrolyte materials exhibiting lithium (Li)-ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is Ge, Zn, or Ga), Li₂S—GeS₂, Li₂S—SiS₂—Li₃PO₄, Li₂S—SiS₂-LiₓMO_{y} (where x and y are positive numbers, and M is P, Si, Ge, B, Al, Ga, or In). The notation “Li₂S—P₂S₅” refers to a sulfide solid electrolyte material obtained using a raw material composition including Li₂S and P₂S₅, and the same applies to the other notations listed above.

Examples of oxide solid electrolyte materials exhibiting Li-ion conductivity include compounds having a NASICON-type structure. Examples of compounds having a NASICON-type structure include compounds (LAGP) represented by the general formula Li₁₊ₓAlₓGe₂₋ₓ(PO₄)₃ (0≤x≤2), and compounds (LATP) represented by the general formula Li₁₊ₓAlₓTi₂₋ₓ(PO₄)₃ (0≤x≤2). Other examples of oxide solid electrolyte materials include LiLaTiO (e.g., Li_{0.34}La_{0.51}TiO₃), LiPON (e.g., Li_{2.9}PO_{3.3}N_{0.46}), and LiLaZrO (e.g., Li₇La₃Zr₂O₁₂).

The binder is not particularly limited as long as it is chemically and electrically stable. Examples include fluorine-based binders such as polyvinylidene fluoride (PVDF) and polytetrafluoroethylene (PTFE), rubber-based binders such as styrene-butadiene rubber (SBR), olefin-based binders such as polypropylene (PP) and polyethylene (PE), and cellulose-based binders such as carboxymethyl cellulose (CMC).

Examples of conductive additives include carbon materials such as carbon fibers, acetylene black, and Ketjenblack, and metal materials such as nickel, aluminum, and stainless steel.

The content of each component in the cathode active material layer 11 and the shape of the cathode active material layer 11 may be the same as in conventional configurations. In particular, from the viewpoint of facilitating the formation of the all-solid-state battery 10, the cathode active material layer 11 is preferably in the form of a sheet. In this case, the thickness of the cathode active material layer 11 is preferably, for example, 0.1 μm or more and 1 mm or less, and more preferably 1 μm or more and 150 μm or less.

### 1.2. Anode Active Material Layer

The anode active material layer 12 is a layer containing at least an anode active material, and may optionally contain at least one of a solid electrolyte, a conductive additive, and a binder. The solid electrolyte, the conductive additive, and the binder may be the same as those used in the cathode active material layer 11.

The anode active material is not particularly limited. However, for a lithium-ion battery, examples of the anode active material include carbon materials such as graphite and hard carbon, various oxides such as lithium titanate, silicon (Si), Si alloys, lithium metal, and lithium alloys.

### 1.3. Solid Electrolyte Layer

In the present embodiment, the solid electrolyte layer 13 is a solid electrolyte layer disposed between the cathode active material layer 11 and the anode active material layer 12. The solid electrolyte layer 13 contains at least a solid electrolyte. The solid electrolyte may be the same as the solid electrolyte described in connection with the cathode active material layer 11.

### 1.4. Current Collector Layers

The current collector layers are the cathode current collector layer 14 that collects current from the cathode active material layer 11, and the anode current collector layer 15 that collects current from the anode active material layer 12. Examples of materials that may be used for the cathode current collector layer 14 include stainless steel, aluminum, nickel, iron, titanium, and carbon. Examples of materials that may be used for the anode current collector layer 15 include stainless steel, copper, nickel, and carbon.

### 1.5. Battery Case

The all-solid-state battery may include a battery case (not shown). The battery case is a case that houses various components, and may be made of, for example, stainless steel.

### 2. Method of Manufacturing Secondary Battery

A method for manufacturing a secondary battery will now be described below using an all-solid-state battery as an example. This description also includes a method for manufacturing a solid electrolyte layer.

### 2.1. Acquisition of Correlation Coefficients

In the present disclosure, in order to obtain an appropriate solid electrolyte layer, parameters that are likely to contribute to obtaining a high-quality solid electrolyte layer, as well as coefficients indicating their degree of contribution, are obtained from among parameters representing the physical properties of a solid electrolyte slurry. To this end, the present embodiment uses a machine learning technique. The procedure is specifically carried out as follows.

### Preparation of Solid Electrolyte Slurry

The solid electrolyte slurry is a composition (paste) for forming a solid electrolyte layer. Specifically, the solid electrolyte slurry is prepared by mixing and dispersing a solid electrolyte, a conductive additive, a binder, and a solvent and further mixing the resultant mixture by stirring.

### Acquisition of Physical Property Data of Solid Electrolyte Slurry

To evaluate the physical properties of the solid electrolyte slurry, parameters, namely shear dependence (flow curve), stress-strain, strain sweep, and frequency sweep, are obtained by various measurement methods using a dynamic viscoelasticity measuring device (rheometer). The flow curves are obtained in both directions: from high shear to low shear and from low shear to high shear.

### Acquisition of Evaluation Data of Coating Film

The prepared solid electrolyte slurry is applied to an aluminum foil by a blade coating method and dried to form a solid electrolyte coating film. This coating film is visually inspected to determine its quality. The results are recorded as evaluation data. The quality of the coating film can be determined based on whether a desired coating film shape is obtained. Examples of “poor” quality include, but are not limited to, protrusions, missing portions of the film (or locally thin areas), and coating streaks.

### Machine Learning

In machine learning, a large amount of “physical property data of the solid electrolyte slurry” and “evaluation data of the coating film” is used for training. Correlations are thus obtained for each parameter, and a learning model based on the parameter that shows the highest correlation is selected. Although the specific machine learning method is not particularly limited, a random forest method (open source) similar to a decision tree model is used to select appropriate explanatory variables based on the values of the correlation coefficients output as learning results. The evaluation data of the coating film is set as the objective variable, and the physical property data (parameters) of the solid electrolyte slurry measured by the dynamic viscoelasticity measurement methods is set as explanatory variables. Machine learning is then performed using these pieces of data to extract parameters (explanatory variables) that exhibit high correlations with the objective variable.

According to a study conducted by the inventors using a large amount of data, “stress-strain” was found to exhibit the highest correlation among the physical property data of the solid electrolyte slurry. Therefore, it is preferable to use a machine learning model obtained based on stress-strain. Among the stress-strain data, it is particularly preferable to use data measured in a shear stress range of 0.01 Pa to 100 Pa.

### 2.2. Manufacturing of Secondary Battery

### Formation of Cathode Layer

A cathode active material is prepared, and materials (such as solid electrolyte, binder, and conductive additive) are mixed with the cathode active material to obtain a cathode paste. Subsequently, the obtained cathode paste is applied to a layer that will serve as a cathode current collector layer to a predetermined thickness, and is then dried to form a cathode layer in which a cathode active material layer is laminated on the cathode current collector layer.

### Formation of Solid Electrolyte Layer

In the formation of a solid electrolyte layer, a solid electrolyte slurry is first prepared as described above. Next, physical property data (parameters) of the solid electrolyte slurry is obtained, and the quality of a solid electrolyte layer that would be formed by applying the solid electrolyte slurry is determined using a learning model selected in the manner described above based on these parameters. Then, the solid electrolyte slurry determined to be “acceptable” in the above determination is applied to the cathode active material layer to a predetermined thickness and dried. As a result, a laminate is obtained in which the cathode active material layer and the solid electrolyte layer are laminated on the cathode current collector layer.

### Formation of Anode Layer

An anode active material is prepared, and materials (such as solid electrolyte, binder, and conductive additive) are mixed with the anode active material to obtain an anode paste. Subsequently, the obtained anode paste is applied to a layer that will serve as an anode current collector layer to a predetermined thickness, and is then dried to form an anode layer in which an anode active material layer is laminated on the anode current collector layer.

### Fabrication of Secondary Battery

The laminate in which the cathode active material layer and the solid electrolyte layer are laminated on the cathode current collector layer as described above is placed on the anode layer with the solid electrolyte layer facing the anode active material layer, and the resultant stack is densified by pressing to form a secondary battery.

### 3. Effects Etc.

According to the manufacturing method of the present disclosure, physical property parameters are measured using a dynamic viscoelasticity measuring device. This allows the quality of a coating film that would be formed by applying the solid electrolyte slurry to be predicted and determined in advance. As a result, wasted coating work can be reduced, and an appropriate coating film can be efficiently obtained.

### 4. Test Examples

### 4.1. Preparation of Solid Electrolyte Slurry and Acquisition of Physical Property Data Thereof

A solid electrolyte slurry was prepared by using a sulfide-based solid electrolyte, a PVDF-based binder, and butyl butyrate as raw materials. Specifically, these materials were mixed and dispersed using an ultrasonic disperser, and the resultant mixture was further mixed with a stirring blade to prepare a solid electrolyte slurry. To evaluate the physical properties of the solid electrolyte slurry, parameters, namely shear dependence (flow curve), stress-strain, strain sweep, and frequency sweep, were obtained by various measurement methods using a dynamic viscoelasticity measuring device (rheometer). The flow curves were obtained in both directions: from high shear to low shear and from low shear to high shear.

### 4.2. Acquisition of Evaluation Data of Coating Films

The solid electrolyte slurry was applied to an aluminum foil by a blade coating method and dried on a hot plate at 100° C. for 30 minutes to obtain a solid electrolyte coating film. The obtained coating film was evaluated by visually inspecting its state to determine whether it is acceptable as described above. Evaluation data was obtained by recording the numbers of acceptable and unacceptable cases.

### 4.3. Machine Learning

A random forest method (open source) similar to a decision tree model was used to select appropriate explanatory variables based on the values of correlation coefficients output as learning results. The evaluation data of the coating film was set as the objective variable, and the physical property data (parameters) of the solid electrolyte slurry measured by the dynamic viscoelasticity measurement methods was set as explanatory variables. Machine learning was performed using these pieces of data, and parameters (explanatory variables) that exhibited high correlations with the objective variable were extracted by the machine learning method.

Table 1 shows the correlation coefficients of machine learning models created using each of the parameters obtained by the dynamic viscoelasticity measurement methods. The results are listed in descending order of correlation coefficient. Based on these results, the machine learning model created using the stress-strain data exhibited the highest correlation coefficient of 0.70, and this model was selected.

TABLE 1

| Parameter | Correlation Coefficient |
|---|---|
| Stress-Strain | 0.70 |
| Strain Sweep | 0.68 |
| Shear Dependence | 0.67 |
| (flow curve from high shear to low shear) | |
| Shear Dependence | 0.51 |
| (flow curve from low shear to high shear) | |
| Frequency Sweep | 0.34 |

Table 2 shows the thixotropic index (TI) values, the NG (non-conforming) ratios (relative to the standard value) predicted by the trained model, and the NG ratios (relative to the standard value) actually measured through visual inspection of the coating film properties. The standard value of 1 was set as the allowable NG ratio limit of the coating film for determining the usability of the solid electrolyte slurry. Values of 1 or less were determined to be acceptable, while values greater than 1 were determined to be unacceptable. The results in Table 2 show that, even in the range of TI values generally regarded as indicating a poor dispersion state of the solid electrolyte slurry, there are slurries that are still usable with NG ratios of 1 or less. This indicates that it is difficult to make predictions and determinations based on the TI value, but by using a machine learning model, such predictions can be made. The TI value is commonly used as an index for evaluating fluids exhibiting thixotropic properties. In this case, viscosity data A (measured at 2 rpm) and viscosity data B (measured at 20 rpm) were obtained using a viscometer, and the TI value was calculated as A/B.

TABLE 2

| | Example 1 | Example 2 | Example 3 | Example 4 | Example 5 | Example 6 |
|---|---|---|---|---|---|---|
| TI Value | 2.7 | 3.8 | 1.9 | 0.9 | 1.8 | 1.3 |
| Machine | 0.92 | 0.48 | 0.82 | 0.96 | 1.87 | 1.84 |
| Learning | | | | | | |
| Model | | | | | | |
| Prediction | | | | | | |
| Coating | 0.71 | 0.43 | 0.93 | 0.95 | 1.92 | 1.87 |
| Film | | | | | | |
| Properties | | | | | | |

Accordingly, it was found that, by using a machine learning model created based on stress-strain data, the quality of a solid electrolyte layer that would be formed by a subsequent coating process can be predicted in advance from the physical property data of the slurry obtained during a solid electrolyte kneading process.

What is claimed is:

1. A method for manufacturing a solid electrolyte layer, the method comprising:
a step of preparing a solid electrolyte slurry by mixing a solid electrolyte, a conductive additive, a binder, and a solvent;
a step of obtaining a parameter of the solid electrolyte slurry using a dynamic viscoelasticity measuring device;
a step of determining quality of a coating film based on the parameter; and
a step of applying the solid electrolyte slurry that has been determined to be acceptable in the step of determining the quality of the coating film.

2. The method according to claim 1, wherein the parameter is obtained from stress-strain.

3. The method according to claim 2, wherein the stress-strain is measured in a shear stress range of 0.01 Pa to 100 Pa.

4. A method for manufacturing a secondary battery, the method comprising the steps of the method according to claim 1.
